(19) United States
(12) Patent Application Publication
(10) Pub. No.: US 2007/0183304 A1
(43) Pub. Date: Aug. 9, 2007

(54) Apparatus and method for digitally implementing a wideband multicarrier

(76) Inventor: Eui Rim Jeong, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/567,538

(22) PCT Filed: Sep. 24, 2004
(86) PCT No.: PCT/KR04/02467

§ 371 Date: Nov. 14, 2006

(30) Foreign Application Priority Data
Sep. 26, 2003 (KR) 10-2003-0066878

(51) Int. Cl. H04J 11/00

(52) U.S. Cl. 370/208; 370/335

(57) ABSTRACT

The present invention relates to an apparatus and a method for implementing a wideband multicarrier by using complex digital modulation. With a conventional analog quadrature modulation, which has been used to modulate a complex digital signal into an intermediate frequency (IF) signal or a radio frequency signal, it is difficult to obtain a precise local oscillator signal. Analog circuits, as many as the number of desired carrier signals in a multicarrier, are required. However, the invention implements a wideband multicarrier by newly employing a digital channelizer and a digital IF modulation portion. Since the former can efficiently generate a plurality of carrier signals having different center frequencies and the latter can up-convert the generated carrier signals into a desired multicarrier, the invention can obtain a more reliable wideband multicarrier and implement a wideband multicarrier in a cost-efffective manner.

### TECHNICAL FIELD

The present invention generally relates to an apparatus and a method for digitally implementing a wideband multicarrier, and more particularly to an apparatus and a method for digitally implementing a wideband multicarrier by using complex digital modulation method.

### BACKGROUND ART

The telecommunication systems such as Code Division Multiple Access 2000 (CDMA-2000), Wideband-Code Division Multiple Access (W-CDMA) and 1X Evolution-Data Optimized (1XEV-DO) are required to provide various applications As the technology regarding information storage media and telecommunication advances, there is an increased demand for wireless communication applications for various multimedia contents such as Internet connection, real time transportation information, wireless broadcasting, video on demand and Internet games. In order to provide these various multimedia contents with a restricted bandwidth, the data transmission of high-speed and high-capacity should be accomplished and the efficiency of the power spectrum should be enhanced.

### DISCLOSURE OF INVENTION

### TECHNICAL PROBLEM

Conventionally, Analog Quadrature Modulation (AQM) was used in order to modulate the complex digital signal into intermediate frequency (IF) signals or radio frequency (RF) signals. In the AQM, there should be a balance between I/Q signal paths; and a local oscillator (LO) signal, that is, sine/cosine pulses should be ideal. However, it is difficult to generate ideal sine/cosine pulses. As such, some problems such as unbalanced I/Q signals and carrier feedthrough may arise. Analog circuits, as many as the number of desired carrier signals in a multicarrier, are required. This makes the overall system difficult to construct, while increasing the power comsumption.

In order to solve the problems of AQM, a digital IF method, which generates the IF signal by using a Numerically Controlled Oscillator (NCO), is widely used. This function is realized by using a Field Programmable Gate Array (FPGA) or an Application Specific Intergrated Circuit (ASIC) chip. If a wideband signal or high digital IF signal is realized by using the FPGA or the ASIC chip, the frequency that the chip operates will be a very important factor. This is because the usable frequency band is restricted by the operating clock in each chip. Specifically, if the chip operates in the clock of Fs, the usable frequency band will be restricted from—Fs/2 to Fs/2. Since the commerical chips operate approximately at the clock speed of 100 MHz, the usable frequency is approximately—50 MHz to 50 MHz, which is not enough to modulate the signal having the bandwidth higher than 20 MHz into the usable frequency. As illustrated above, in the conventional digital IF modulation, the usable frequency band is restricted by the digital clock frequency, thus restricting the applicable signal bandwidth and the IF band.

### Technical Solution

It is, therefore, an objective of the present invention to provide an apparatus and a method for inplementing a wideband multicarrier by using a two-step digital IF modulation method. In this respect, the present invention can ensure a wide bandwidth and modulate the wideband multicarrier signal into a sufficiently high IF signal.

Another object of the present invention is to provide an apparatus and a method for implementing a wideband multicarrier that can be realized in a simple way instead of the conventional AQM, and can further overcome the problem such as the image signals caused by the unbalanced I/Q signals.

In order to achieve the object of the present invention, the invention ensures the sufficient band by using the two-step digital IF modulation method. The first embodiment of the present invention for achieving the above objective is an apparatus for implementing a wideband multicarrier comprising the following features: a digital channelizer for (1) pulse-shaping complex digital modulation signals, (2) digitally mixing the signals and (3) dividing the signals into individual signals having different center frequencies; and a digital IF modulation portion for modulating the divided signals into individual IF signals to generate a wideband multicarrier IF signal

The second embodiment of the present invention for achieving the above objective is a method for implementing a wideband multicarrier comprising the following steps: pulse-shaping complex digital modulation signals; digitally mixing the signals; dividing the signals into individual signals having different center frequencies; interpolating the divided signals; quadrature-mixing the signals; and modulating the signals into digital IF signals.

### Advantageous Effects

According to the present invention, the wideband multicarrier is implemented by newly employing a digital channelizer and a digital IF modulation portion. Hence, it is possible to obtain a more reliable wideband multicarrier and implement a wideband multicarrier in a cost-effective manner.

The foregoing and other objects and features of the present invention will become more fully apparent from the following description, appended claims and their accompanying drawings.

### BRIEF DESCRIPTION OF THE DRAWINGS

Understanding that these drawings depict only typical embodiments of the invention and are, therefore, not to be considered limiting of its scope, the invention will be described with additional specificity and detail through use of the accompanying drawings in which:

FIG. 1 is a schematic view of an apparatus for implementing a wideband multicarrier by using a complex digital modulation method according to the present invention.

FIG. 2 is a detailed diagram illustrating a pulse shaper and a complex mixer in the digital channelizer according to the present invention.

FIG. 3 illustrates the input power spectrum to the pulse shaper shown in FIG. 2.

FIG. 4 illustrates the output power spectrum from the pulse shaper shown in FIG. 2.

FIG. 5 illustrates the output power spectrum from the complex mixer shown in FIG. 2.

FIG. 6 illustrates the output power spectrum from the digital channelizer shown in FIG. 1.

FIG. 7 is a detailed diagram illustrating the digital IF modulation portion shown in FIG. 1.

FIG. 8 illustrates the standard of up-samplers and interpolation filters in the digital IF modulation portion shown in FIG. 7.

FIG. 9 illustrates the output power spectrum from the interpolation filter shown in FIG. 7.

FIG. 10 illustrates the output power spectrum from the IF up-converter shown in FIG. 7.

### BEST MODE FOR CARRYING OUT THE INVENTION

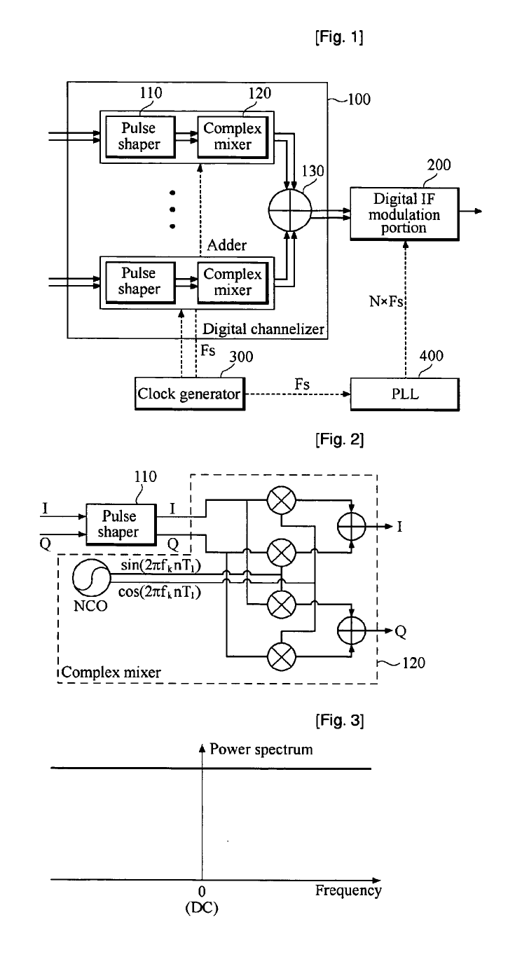

It will be readily understood that the components and steps of the present invention, as generally described and illustrated in the Figures herein and accompanying text, could be arranged and designed in a wide variety of different configurations while still utilizing the inventive concept. Thus, the following detailed description of the preferred embodiments of the method of the present invention, as represented in FIGS. 1 through 10 and accompanying text, is not intended to limit the scope of the invention, as claimed. It is merely representative of the presently preferred embodiments of the invention. The presently preferred embodiments of the invention will be best understood by reference to the drawings, wherein like parts or steps are designated by like numerals throughout.

The present invention utilizes the complex digital modulation. It can be applied to the transmitting section in the base station of the telecommunication systems such as CDMA-2000, CDMA200 1X EV-DO, W-CDMA and GSM. The present invention can also implement the multicarrier signal having the bandwidth higher than 20 MHz in a single signal path.

The operations of the above will be described in further detail as follows.

FIG. 1 is a schematic view of an apparatus for implementing a wideband multicarrier according to the present invention. The apparatus for implementing a wideband multicarrier will be described in detail with reference to FIG. 1. The apparatus for implementing a wideband multicarrier comprises a digital channelizer 110 for (1) pulse-shaping a complex digital modulation signal, (2) digitally mixing the signal and (3) dividing the signal into individual signals having different center frequencies; and a digital IF modulation portion 200 for modulating the divided signals into individual IF signals to generate a wideband multicarrier IF signal.

The apparatus for implementing a wideband multicarrier is provided with the modulated signals according to telecommunication standard. Digital channelizer 100 divides a wideband multicarrier into narrowband individual signals, generating the divided signals with a DC frequency in the center. Then, digital IF modulation portion 200 modulates the signals into the individual IF signals. The modulated multicarrier signals according to the present invention can be converted into analog signals by using a digital-analog converter (DAC) and processed with the conventional method.

The apparatus for implementing a wideband multicarrier according to the present invention further comprises clock generator 300 and phase-locked loop (PLL) 400. Clock generator 300 provides clocks to digital channelizer 100. PLL 400 makes the clock from clock generator 300 into N individual clocks and provides them to digital IF modulation portion 200.

Digital channelizer 100 performs relatively complicated functions such as pulse-shaping and complex mixing with a low speed, thus providing a high resolution NCO. Digital IF modulation portion 200 performs relatively simple functions such as interpolation and frequency conversion with a high speed, hence providing a high frequency NCO with a relatively low resolution. The present invention use this two-step digital IF modulation, thus making it possible to have the merit of digital IF modulation and obtain wideband. Therefore, the present invention can modulate the wideband multicarrier signals into sufficiently high IF signals.

FIG. 2 is a detailed diagram showing the inner configuration of digital channelizer 100 according to the present invention. As illustrated in FIG. 2, digital channelizer 100 comprises: a plurality of pulse shaper 110 that separates each channel from the adjacent channel; a plurality of complex mixer 120 that performs complex modulation per channel; and adder 130 that adds I signals and Q signals from complex mixer 120.

Pulse shaper 110 according to the present invention performs the function of restricting the bandwidth of each channel signal. This pulse shaping can be performed according to the specification of each telecommunication system. For example, CDMA-2000 is realized with a low pass filter, while W-CDMA is realized with a root raised cosine (RRC) filter.

Specifically, the complex modulated digital signals are inputted to pulse shaper 110. For example, the signals modulated by phase shift keying (PSK), quadrature amplitude modulation (QAM) or minimum shift keying (MSK) can be processed by the wideband multicarrier implementing apparatus according to the present invention. The speed of input data is determined according to each standard. For example, the speed in case of CDMA-2000 1X/1XEV-DO is 1.2288 Msps, while the speed in case of W-CDMA is 3.84 Msps.

The pulse shaping of the present invention determines the quality of transmission signal and the adjacent channel interference, thus affecting the system performance. Therefore, the present invention uses a high performance pulse shaper, which requires a lot of computation.

The output signals from pulse shaper 110 are inputted to complex mixer 120. Then, complex mixer 120 modulates the phase and the magnitude of the inputted signals. Complex mixer 120 can be realized with various methods, and the NCO is used in the embodiment of FIG. 2. The NCO generates cosine and sine waves, and the cosine and sine waves from NCO are multiplied by the signals from pulse shaper 110. In case the complex mixer 120 is realized by using the NCO, clock generator 300 provides the clocks to the NCO of complex mixer 120 in digital channelizer 100.

When the time period outputted from pulse shaper 110 is T₁, I signal outputted from complex mixer 120 is

$$I \times cos ( 2 π {f}_{k} {nT}_{1} ) - Q \times sin ( 2 π {f}_{k} {nT}_{1} ) ,$$

and Q signal from complex mixer 120 is

$$I \times sin ( 2 π {f}_{k} {nT}_{1} ) - Q \times cos ( 2 π {f}_{k} {nT}_{1} ) .$$

The NCO frequency, fₖ, needs to be set so that the signals from different channels are not overlapped. I and Q signals that are digitally complex-mixed are added in adder 13 and transferred to digital IF modulation portion 200.

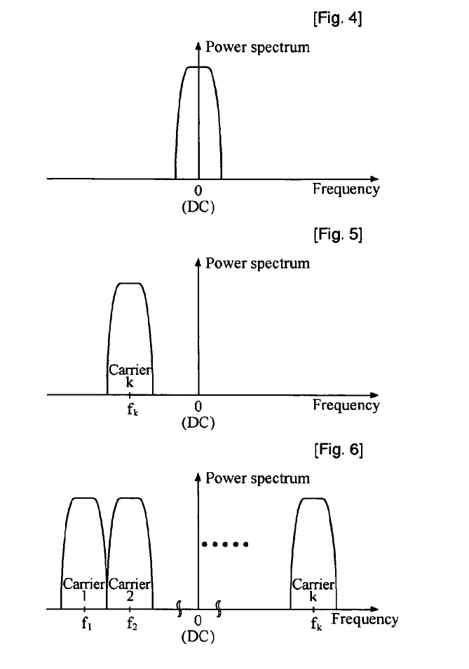

The signal spectrum as processed in digital channelizer 100 is shown in FIG. 3 to FIG. 6. The signal that is inputted to digital channelizer 100 is flat over the whole frequency band as shown in FIG. 3. However, when pulse shaper 110 processes the signal, the power spectrum becomes limited in a channel as shown is FIG. 4. For example, the frequency band of CDMA 2000 1X/1X EV-DO is 1.25 MHz, and the frequency band of W-CDMA is 5 MHz. When complex mixer 120 complex-mixes the signal limited in a channel by pulse shaper 110, the power spectrum becomes asymmetric from a DC frequency in the center as shown is FIG. 5.

When the narrowband signals whose number is the same as the number of the carrier waves are added in adder 130, the power spectrum becomes as shown in FIG. 6. As shown therein, there appears a plurality of narrowband signals whose carrier frequencies are different from each other. As illustrated in FIG. 6, the present invention is characterized in that the signals of each channel are modulated with a DC frequency in the center by using complex modulation method.

Since the present invention uses complex mixing, it is possible to use minus frequency. Therefore, the signals of each channel are positioned with a DC frequency in the center, which leads to the effective use of frequencies. For example, in order to make the multicarrier signal whose overall bandwidth is 20 MHz, it only needs to convert each carrier wave from —10 MHz to 10 MHz. This means that it is sufficient to use 10 MHz in absolute value to make 20 MHz signal. If the clock frequency of digital channelizer is Fs, then the usable frequency band is—Fs/2 to Fs/2. Considering the characteristics of the DAC and filtering of analog portion, it is preferable to use the frequency band that is close to the DC frequency in the center.

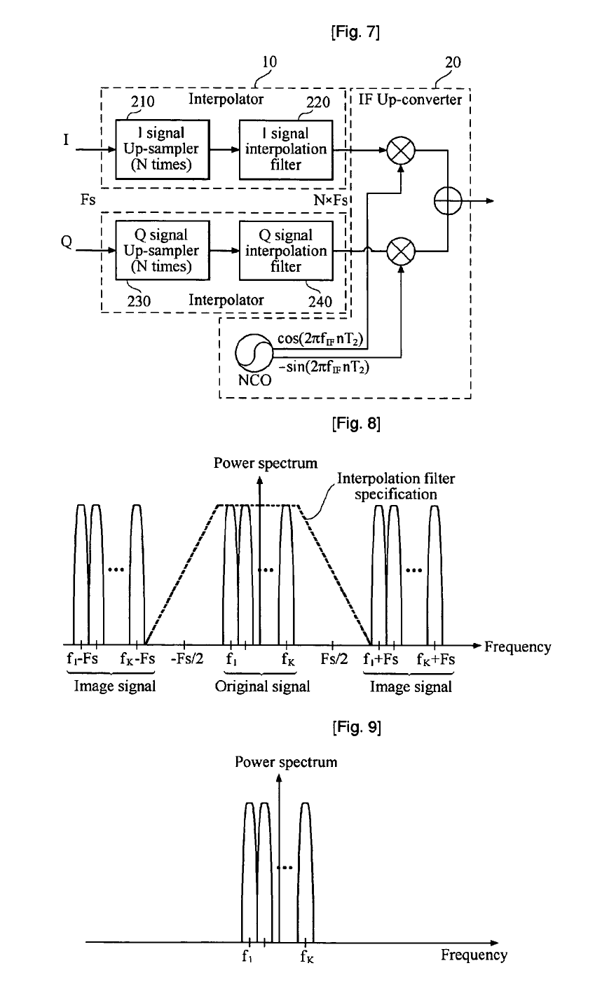

Digital IF modulation portion 200 according to the present invention modulates the overall signals outputted from digital channelizer 100 into the IF signals. FIG. 7 illustrates the inner configuration of digital IF modulation portion 200. Digital IF modulation portion 200 comprises interpolator 10 that up-samples the signals in order to increase a data speed and interpolation-filters the up-sampled signals. This is to remove the image signals due to up-sampling. It also comprises IF up-converter 20 that modulates the signals outputted from interpolator 10 into the IF signals.

Interpolator 10 comprises: I signal up-sampler 210 that receives the I signal from digital channelizer 100 and inserts 0 between the signals in order to increase a data speed; I signal interpolation filter 220 that filters image signals from the signals inputted from I signal up-sampler 210; Q signal up-sampler 230 that receives the Q signal from digital channelizer 100 and inserts 0 between the signals in order to increase a data speed; and Q signal interpolation filter 240 that filters image signals from the signals inputted from Q signal up-sampler 230. Since digital IF modulation portion 200 operates in N times clock of Fs, the usable frequency band is—Fs×N/2 to Fs×N/2. Therefore it is possible to modulate the wideband signals into the sufficiently high IF signals. Further, the digital IF modulation portion 200 needs to be operated well at the clock speed of N×Fs. As such, it is necessary to simplify the computation in digital IF modulation portion 200 in order to ensure high speed processing.

FIG. 8 illustrates the standard of up-samplers 210, 230 and interpolation filters 220, 240 according to the present invention. As shown in FIG. 8, the overall signals are repeated at the input data speed Fs of up-samplers 210, 230. However, interpolation filters 220, 240 filter the image signals, f₁−Fs to fₖ−Fs and f₁+Fs to fₖ+Fs, except the original signal, f₁to fₖ. Interpolation filters 220, 240 should have the specification represented by the dotted line in FIG. 8.

The most computation that is performed in the interpolation process is related to interpolation filtering. Therefore, it is important to minimize the number of taps of interpolation filters. Since the signals assemble around the DC frequency in the center by digital channelizer 100 according to the present invention and there is enough space between the original signal and the image signals, it is possible to filter the image signals without using many taps. The present invention can be easily realized by using two-times interpolation several times in multi-step. In this way, the possible interpolation factors are restricted in the power of 2 such as 2, 4 and 8. FIG. 9 illustrates the power spectrum of the filtered signal, wherein the image signals were removed.

IF up-converter 20 modulates the signals outputted from interpolation filters 220, 240 into the IF f_{IF} signal. FIG. 7 illustrates one example of IF up-converters. IF up-converter 20 shown in FIG. 7 comprises: a NCO that generates sine and cosine waves; multipliers that multiply I and Q signals inputted from interpolator 10 by the sine and cosine waves inputted from the NCO; and an adder that adds the signals from the multipliers and generates a wideband multicarrier IF signal that comprises a plurality of narrowband IF signals whose carrier frequencies are different from each other.

The cosine and sine waves are generated in the NCO and multiplied by I and Q signals that are outputted from interpolator 10 in the multipliers. Then, the multiplied values are added in the adder. Consequently, the output signal from IF up-converter becomes the value of I×cos (2pf_{IF}nT₂)—Q×sin (2pf_{IF nT}₂). When the If up-converter is realized by using the NCO according to the present invention, PLL 400 receives the clock Fs from clock generator 300 and supplies the clock N×Fs to the NCO that controls the frequency of IF up-converter 20 in digital IF modulation portion 200.

High-speed multipliers can be realized with the known technologies and NCO can be realized with a look-up table method. Therefore, it is easy to realize high-speed digital IF modulation portion 200.

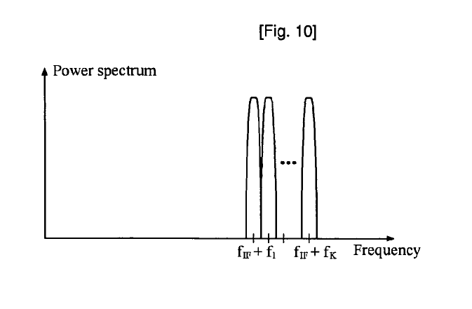

FIG. 10 illustrates the power spectrum that is outputted from digital IF modulation portion 200. The power spectrum is shifted by f_{IF} as shown in FIG. 10.

In another embodiment of the invention, digital IF modulation portion 200 can be realized with only the NCO without the multipliers, wherein the NCO restricts the expressible frequencies. For example, when the signals are converted only with the frequencies that corresponds to a fourth of the data speed, sin (2pf_{IF}nT₂) will have only the values of 0, 1, 0 and-1. If digital IF modulation portion 200 restricts the If range, some problems may arise when an analog portion that follows the DAC converts the signal into the RF signal. This is because the analog portion needs to generate a local oscillator (LO) signal that has a good resolution in order to convert the signal into the RF signal. For example, let's assume that the digital IF modulation portion in CDMA 2000 1X/1XEV-DO operates in 314.5728 Msps, which is 256 times of the data speed, 1.2288 Msps. If the IF signal is converted into a fourth of data speed in order to simply realize the NCO, then the IF f_{IF} will be 78.6432 MHz. In order to convert this IF signal into the RF signal, the analog portion should make the LO signal that has the resolution of 200 Hz or more. It is practically difficult to have such a high resolution while generating 900 MHz to 2 GHz RF LO frequencies. In order to solve this problem, the NCO in the digital channel dividing step needs to compensate the resolution that is restricted in the digital IF modulation step. In the above case, if the overall signal is positioned with—0.6432 MHz (not DC frequency) in the center in the digital channel dividing step, the signal will be converted into the IF of 78.6432 MHz and then be positioned at 78 MHz, which can be easily converted into the RF signal. Therefore, the NCO of the digital channelizer needs to have a good resolution in order to represent a considerably precise frequencies, which can simplify the computation of the digital IF modulation step and easily implement the analog portion.

In the present invention that implements the wideband multicarrier, the complex digital modulated signal in an arbitrary method is first pulse-shaped. Subsequently, the pulse-shaped signal is divided and distributed into individual channels through the complex digital mixing. Then, the divided signals are converted into the digital IF signals through interpolation and quadrature mixing.

### INDUSTRIAL APPLICABILITY

In accordance with the present invention, it is possible to simply implement the wideband multicarrier signal in one digital signal path. The invention implements a wideband multicarrier by newly employing a digital channelizer and a digital IF modulation portion. The former can efficiently generate a plurality of carrier signals having different center frequencies and the latter can up-convert the generated carrier signals into a desired multicarrier. Thus, the invention can obtain a more reliable wideband multicarrier and implement a wideband multicarrier in a cost-effective manner.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the scope of the invention.

1. An apparatus for implementing a wideband multicarrier, the apparatus comprising:
a digital channelizer for pulse-shaping complex digital modulation signals, digitally mixing the signals and dividing the signals into individual signals having different center frequencies; and
a digital intermediate frequency (IF) modulation portion for modulating the divided signals into individual IF signals to generate a wideband multicarrier IF signal.

2. An apparatus for implementing a wideband multicarrier as recited in claim 1, the apparatus further comprising:
a clock generator for supplying a clock signal to the digital channelizer; and
a phase locked loop (PLL) for receiving the clock signal from the clock generator and supplying an N times multiplied clock signal to the digital IF modulation portion.

3. An apparatus for implementing a wideband multicarrier as recited in claim 1 or 2, the digital channelizer comprising:
a plurality of pulse shapers for receiving the complex digital modulation signal and separating each channel signal from adjacent channel signals;
a plurality of complex mixers for complex-modulating each of the channel signals outputted from the respective pulse shapers; and
an adder for adding I and Q signals that are complex-modulated from the plurality of complex mixers.

4. An apparatus for implementing a wideband multicarrier as recited in claim 1 or 2, the digital IF modulation portion comprising:
an interpolator for up-sampling the signal in order to increase a data speed and interpolation-filtering the signal in order to remove the image signals; and
an IF up-converter for modulating the signal outputted from the interpolator into an IF signal.

5. An apparatus for implementing a wideband multicarrier as recited in claim 4, the interpolator comprising:
an I signal up-sampler for receiving the I signal from the digital channelizer and inserting 0 between the signals in order to increase a data speed;
an I signal interpolation filter for filtering image signals from the signals inputted from the I signal up-sampler;
an Q signal up-sampler for receiving the Q signal from the digital channelizer and inserting 0 between the signals in order to increase a data speed; and
an Q signal interpolation filter for filtering image signals from the signals inputted from the Q signal up-sampler.

6. An apparatus for implementing a wideband multicarrier as recited in claim 4, the IF up-converter comprising:
a numerically controlled oscillator (NCO) for generating sine and cosine waves:
a multiplier for multiplying I and Q signals inputted from the interpolator by the sine and cosine waves inputted from the NCO; and
an adder for adding the signals from the multipliers and generating a wideband multicarrier IF signal that is comprised with a plurality of narrowband IF signals whose carrier frequencies are different from each other.

7. An apparatus for implementing a wideband multicarrier as recited in claim 3, wherein the clock generator provides the clock signal to the plurality of complex mixers in the digital channelizer.

8. An apparatus for implementing a wideband multicarrier as recited in claim 6, wherein the PLL receives the clock signal from the clock generator and supplies the clock signal to the NCO that controls the frequency of the IF up-converter in the digital IF modulation portion.

9. An method for implementing a wideband multicarrier, the method comprising the steps of:
pulse-shaping complex digital modulation signals;
digitally mixing the signals;
dividing the signals into individual signals having different center frequencies;
interpolating the divided signals;
quadrature-mixing the signals; and
modulating the signals into digital IF signals.
